(19) United States
(12) Patent Application Publication
(10) Pub. No.: US 2020/0342540 A1
(43) Pub. Date: Oct. 29, 2020

(54) STRUCTURED INVESTMENT PRODUCT, WITH TRANCHES OF MBS (MORTGAGE BACKED SECURITIES) POOLED PER DOWNSIDE PRICING RISK OF COLLATERAL ASSET

(71) Applicant: Wenching Grace Lu, Missouri City, TX (US)

(72) Inventor: Wenching Grace Lu, Missouri City, TX (US)

(21) Appl. No.: 16/917,607

(22) Filed: Jun. 30, 2020

Related U.S. Application Data
(63) Continuation-in-part of application No. 15/656,911, filed on Jul. 21, 2017.

(51) Int. Cl. G06Q 40/06

(52) U.S. Cl. CPC G06Q 40/06

(57) ABSTRACT

The pooling of mortgage backed securities (MBS) will have tranches per risk of principal perseverance based on historical statistic figures of assets downside pricing variances. Tables providing verifiable data regarding downside risk are available to the investor.

### CROSS-REFERENCE TO RELATED APPLICATIONS

This application is a continuation in part of a U.S. patent application Ser. No. 15/656,911 filed on Jul. 21, 2017, which is incorporated herein by reference in its entirety.

### FIELD OF INVENTION

The present invention relates to an investment product, and particularly, relates to a system and method for structuring a mortgage-based investment product.

### BACKGROUND

Mortgage Backed Securities (MBS) being long-term in nature is a good vehicle for corporate pension fund, annuity life insurance institution, etc. to hedge against their long-term liability with the confident of not only generating reasonable income but also preserving principal of their investment. Banks with majority of their liabilities (deposits, CD, etc.) in shorter term; therefore, would prefer packaging their mortgage assets in the secondary market to reduce the risk of assets vs. liability duration mismatch.

However, many investors have refrained from MBS since there have been a high degree of skepticism regarding the market. Many institutional investors have limits to hold below-investment-grade debt. This can take the form of regulations, capital requirements, or investment restrictions imposed by committee. Bond insurers also have been on the hot seat during credit crisis as their ability to insure and back MBS. MBS (RMBS-residential, CMBS-commercial, etc.) being the largest one (dollar amount wise) in size among all Asset Backed securities (ABS). Bring transparency and confident back will help promoting the marketability of MBS.

To access the risk of MBS investment, risk characteristics of borrower, collateral, and loan itself can be evaluated. Due to the long term duration in nature, the on-going maintain of FICO score which provide lots of information regarding characteristics of borrower for the vast pool of MBS (which is in the trillion dollars market) is deem in-effective. If we perform an audit of the FICO score, there will be some changes any time. What percentage of accuracy is then considered valid? Not to mention, borrower's consent is typically required to obtain such information; therefore, making this approach impractical.

The mortgage industry also relies on property value determinations, frequently involving a human appraiser who can sometimes be less objective. Conventional mortgage scoring only uses a point estimate of the value of the property, and no forecast of the future direction of the price of the property. Weighted Average Margin Test measure the difference between market value and face value of collateral. Again, market value could be subjective; therefore, making these types of data less verifiable. “Law of One Price” suggests that securities should have the same market value as its underlying collateral. In practices, this is often not the case.

Because quality of securitized assets is ever changing due to time and structure-dependent volatility, this type of security has an inherent risk to the structure. Credit crunch has confirmed that ABS poses risk to financial market due to fundamental flaw that causes all tranches to be extremely high-risk for investors. Severe downturn in the housing market was not modeling for collateral of RMBS market. Investors unable to gauge ABS structure and performance relied on ratings which also collapsed during crisis.

Covered Business Method which covers financial products such as credit, loans, real estate transaction, securities, and investment products but not a technological invention per AIA 18 (d)(1); see 37 C.F.R. 42.301(a). Claims of this method contain financial activity element and related generally to monetary matters. What was invented is a new type of business method to structure financial products under CBM (Covered Business Method). Technology is specifically excluded under the CBM category which is understandable for data is considered information which if licensed will deprive people of knowledge; however, CBM do cover financial products. In this case, the business method in generating unconventional structured financial product in specific $amount based upon objective statistical calculation backed with verifiable database as the inventive concept and improvement to solve lack of transparency; therefore, capital liquidity issue for mortgage backed securities which has been traded for decades on the market as investment products.

The inventive concepts to structure MBS unconventionally by integrating mass pool of individual mortgages with objective (improved feature) statistical standard deviation calculation of foreclosed property market final sales prices fall short of original collateral values based on verifiable (improved feature) historical data instead of subjectively trenching mortgages by principal only or interest only which have been the prevailing business practice for decades. Therefore, the steps of claim method based on objective statistical calculation backed with verifiable historical databases are extra-solution activity to promote healthy capital structure and market liquidity of this type of products which drastically shrunk more than 10 years ago.

There is a need for an improved method that provides a practical and objective measurement of risk. (E.g. the risk of principal perseverance). The design of this product means to increase liquidity and marketability of MBS by giving investors confident regarding the risk in which investors' capital contribution is protected.

### SUMMARY OF THE INVENTION

The principal object of the present invention is therefore directed to a computing system and method for structing mortgages as an investment product.

In one aspect, the present invention is directed to computer implemented method for structuring mortgage-backed security into tranches per statistical standard deviation of downside pricing variance of collateral, the method comprising retrieving, by a computing system, foreclose-property historical performance database configured to compute and store several bound of standard deviation of percentage of final market sale price fall short of original collateral value of a plurality of foreclose property for a predetermined period as tranches structure guiding rules to tranche asset backed security; retrieving, by a computing system, current on the market active mortgage database to integrate databases with self-referral software to link down payment % of active mortgages with tranches structure guiding rules of foreclose property historical performance database from step (a) above; processing, by the computing system, the current on the market active mortgage database with software sorting function to change order of individual mortgages per updated tranche field code into pool of tranches as structural mortgage backed securities in $amount tranches wherein percentage of active mortgage down payment is within structure guiding rules bounded by standard deviation of downside pricing variances of original collateral as market tradable products backed with historical databases and standard deviation calculations of assets downside pricing variances.

These and other objects and advantages of the embodiments herein will become readily apparent from the following detailed description.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram of the system.

FIG. 2 is a block diagram of a server.

FIG. 3 is a table showing an embodiment of the foreclosed property's historical performance database.

FIG. 4 is a table showing an embodiment of the historical MBS performance database.

FIG. 5 is a table showing an embodiment of the current on the market active MBS database.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation. Moreover, the drawings may not be to scale.

Disclosed herein is a system and a method to structure an investment product as pooled tranche per risk of principal perseverance. In one implementation, the investment product is mortgage backed securities pooled into tranche per risk of principal perseverance. MBS, due to long term in nature, disproportionate number of borrowers with high credit ratings my leave the pool over time resulting in degradation of the security due to increased risks of defaults associated with the remaining borrowers. Presently, this adjustment over time to reflect the change in condition is not available to investors or to rating agencies. This design to pool tranche per down payment, as time passed, the weighted average loan balance to collateral for the pool will get smaller; therefore, with even lower risk.

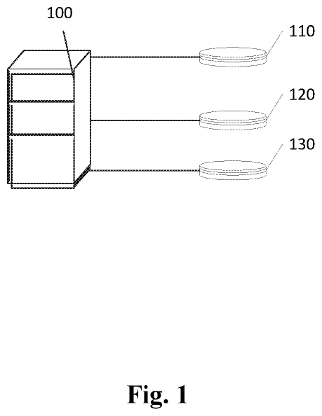

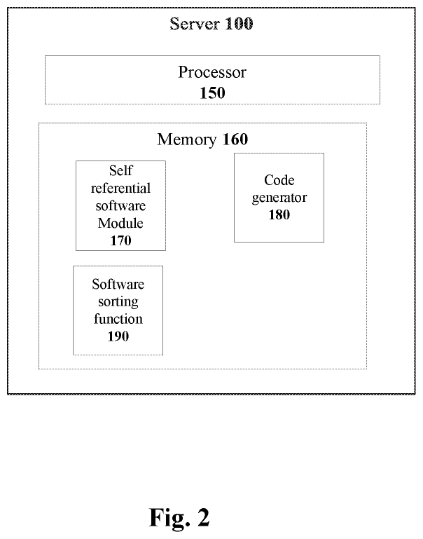

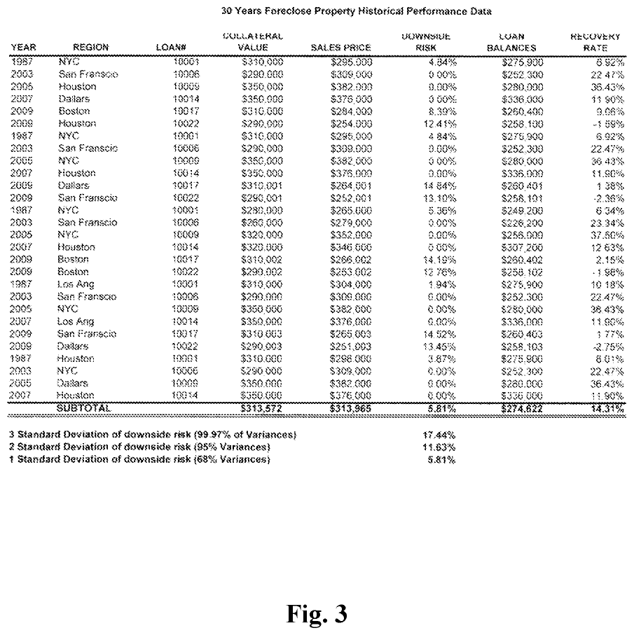

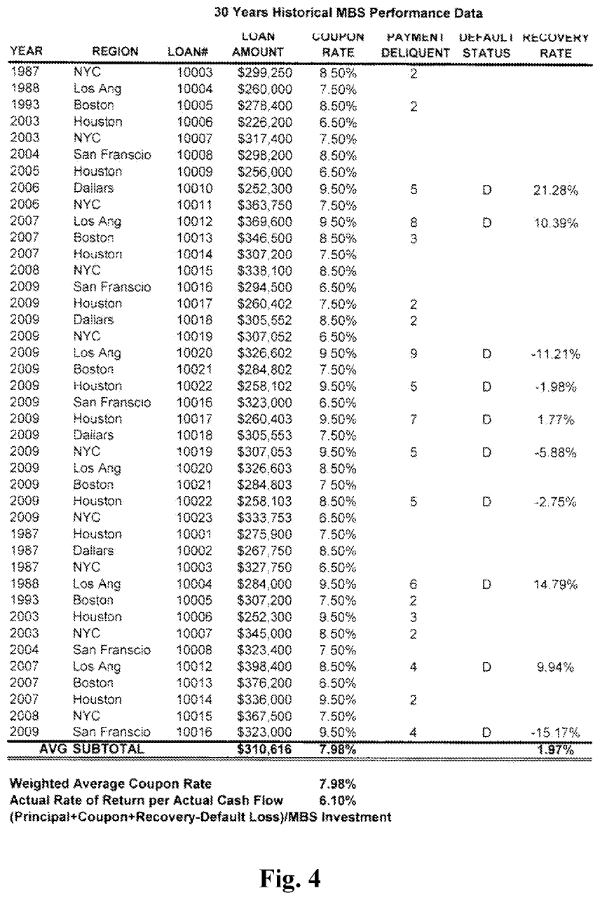

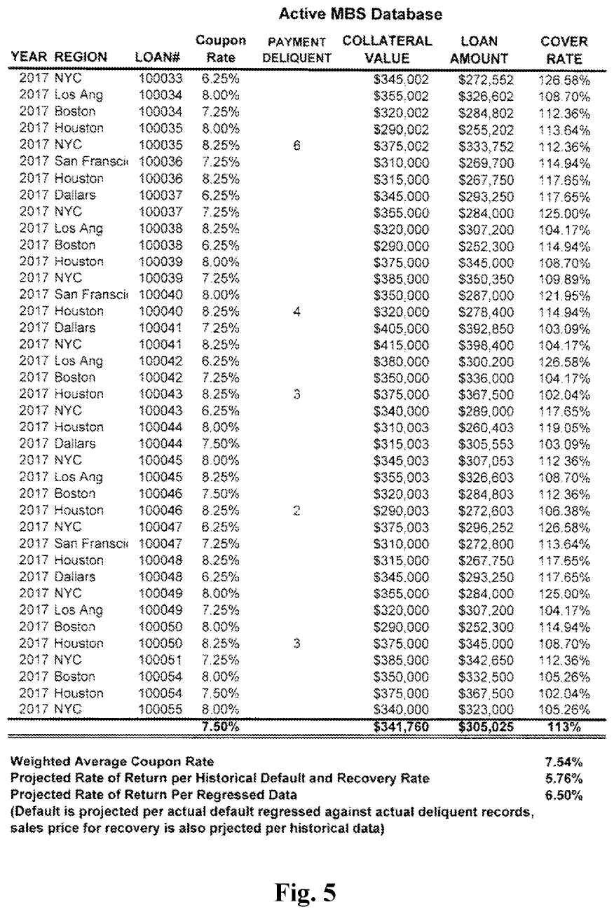

Now referring to FIG. 1 which is block diagram of the system, which is a computing system, that includes a server 100, a foreclosed property's historical performance database 110, historical MBS performance database 120, and active MBS database 130. One implementation of the foreclosed property's historical performance database 110 is shown in FIG. 3. One implementation of the historical MBS performance database 120 is shown in FIG. 4. One implementation of the active MBS database 130 is shown in FIG. 5. FIG. 2 is a block diagram showing one implementation of the server 100. As shown in FIG. 2, the server 100 includes a processor 150 and a memory 160. The memory 160 includes a self-referential software module 170, code generator 180, and software sorting function 190. The self-referential software module 170, code generator 180, and software sorting function 190 can be executed by the processor 150 for structuring the mortgage backed securities as pooled tranche per risk of principal perseverance.

The foreclose property historical performance database 110 allows assessing risk of foreclose loss. FIG. 3 shows a 30 years' historical data which cover several market stress terms. Based on the foreclose property historical performance database 110, tranches can be pooled per statistic standard deviation of downside market pricing variances with perseverance of principal as main concern.
1. Risk Free tranche (99.97% variances covered)—down payment more than 18% (17.44% run up)
2. Grade AA Tranch (95% covered)—down payment more than 12% (11.63% run up)
3. Investment Grade Tranch (68% covered)—down payment more than 6% (5.81% run up)
4. Speculated Tranch—down payment less than 6% (5.81% run up)

If downside 3 standard deviation of % of historical market price fall short of original collateral is 17.44%, pooling tranche with mortgage down payment more than 18% will cover more than 99.97% of downside market pricing variances; therefore, is considered risk free tranche. As time passed, the weighted average loan to collateral ratio for the pool will get smaller; therefore, the original risk assumed is lower as time passed. Tranches pooled between downside risk of 2 standard deviation and 1 standard deviation will be protected against 68% of downside market price variances. Per example data provided under FIG. 3, tranches pooled with down payment between 18% and 6% are then considered investment grade tranches. Speculated tranche with down payment less than 6% (5.81% run up) is then with the highest risk of downside pricing variances; however, is also reimbursed with higher interest rate. If there are a lot less liquidity for the speculated tranche, then underwriting organizations will gradually tighten their lending policy and require higher down payment since there are few willing to subside this type of speculated risk. If sophisticated investors finding opportunities to garb higher return during market up cycle, then there is marketability for speculated tranche. Lending policy will then be driven by market force. The main point is that risk need to be clearly disclosed per verifiable database and available to the public. As time passed, the weighted average loan to collateral ratio for all tranches will get smaller; therefore, the original risk assumed is lower as time passed.

Pooling and naming of tranche described above are not limited to these four tranches structure guiding categories provided and could be more granular or more general per needs. The exact composition of pool may vary depending on the goals of the vehicle. Pooling of tranche could be also enhanced with other critical data per type of assets (ex. rent rate for commercial property, etc.) the main idea here is to pool tranches per actual historical statistic data with clear down side risk assessment and perseverance of principal as main concern. Other risk statistic factors could also be integrated in the system.

FIG. 3 displays 30 years foreclose property historical performance data of similar type of MBS. The foreclose property historical performance database is configured to compute and store standard deviation as structure guiding rules to tranche asset backed security. Steps to generate database structure guiding rules including utilizing software module programmed with logical function (if) sales price is greater or equal than collateral value of foreclose property historical performance database then converting with equal function the downside risk field to zero since pricing variance of negative loss is the only concern; otherwise, subtracting sales price with software subtraction function by collateral value over collateral value with software division function as the % of downside pricing variance; determining the standard deviation of % of asset sales prices fall short of original collateral value by utilizing software module equipped with database table function configured to weighted average subtotal standard deviation and calculating the weighted average subtotal of % of downside risk field; calculating and storing with a recordable storage medium equipped with hardware memory for 30 years pool of asset data to compute statistical 3, 2, and 1 standard deviation of % of asset sales prices fall short of original collateral value by multiplying 3, 2, and 1 to the weighted average variances subtotal derived from previous step by utilizing software module configured with multiply function.

FIG. 4 displays 30 years historical mortgage backed security performance data of similar type of MBS. By comparing Weighted Average Coupon Rate vs. Actual Rate of Return per Actual Cash Flow, we will notice there is several base point differences between stated and actual rate. All fields are not covered, for example, prepayments need to be incorporated to calculate actual rate of return. The main idea is to have verifiable data available to the public calculating actual return per historical data and listing actual cash flow including default loss and recovery payment. More disclose could be added per type of property or needs of institution. The main idea here is verifiable data to gauge the difference between stated rate and actual rate.

FIG. 5 displays similar data as FIG. 4, except FIG. 5 is an active MBS pool currently on the market. To project potential default rate, current delinquent payment records are to be regressed against historical 30 years MBS delinquent data. To project recovery rate, potential delinquent loan collateral is regressed against historical foreclosed property. Projected rate of return is calculated per historical default and recovery rate which is 5.76% in this example. Projected Rate of Return per actual delinquent records is 6.5% since current market condition is better with less payment delinquent. Also, per 30 years' historical data which cover several market stress terms, rate of return is deem lower and more conservative. Please also note that the weighted average cover rate of Collateral to Loan ratio at the bottom right of the corner is 113% for this actual MBS packaged to be sold. If investor is buying the Grade AA tranche, reviewing the actual database will validate that coverage rate 13% is more than 12% as proposed per statistic downside risk factor under FIG. 3. Structuring active MBS database comprises receiving by current on the market active mortgage performance database with electronic hardware equipped with self-referential software table linking lookup function programmed to link statistical calculated 3, 2 and 1 standard deviation of % of asset sales prices fall short of original collateral assets prices from 30 years (or shorter) of foreclose property historical performance database (FIG. 3); updating tranche field of current on the market active mortgage performance database configured with code generator to generate tranche code by integrating active market mortgage's down payment % with a self-referential software module database table function look up routed statistical calculated 3, 2, and 1 standard deviation of % of asset sales prices fall short of original collateral value from historical foreclose property performance database (FIG. 3) with programmed logical function if down payment % is within the bound of said structure guiding rules; assigning a risk free tranche code for a tranche pooled with mortgage down payment % of active mortgages equals or more than calculated 3 standard deviation of historical foreclosed properties % of sales prices fall short of original asset prices to protect against 99.97% or more of downside pricing variances is a risk free tranche by utilizing self-referential software module programmed with logical function (if) % of mortgage down payment divided with division function by collateral value greater or equal than embedded 3 standard deviation of % of asset sales prices fall short of original collateral value routed from foreclose property historical performance database (FIG. 3) then generating a risk free code with code generator for the mortgage; assigning an investment grade tranche for a tranche pooled with mortgage down payment % of active mortgage between bound of calculated 1 & 2 standard deviation of historical foreclosed properties % of sales prices fall short of original asset prices to protect against 68% of downside pricing variance is an investment grade tranche by utilizing self-referential software module programmed with logical function (if) % of mortgage down payment divided with division function by collateral value is greater or equal 1 standard deviation but less or equal 2 standard deviation of % of asset sales prices fall short of original collateral value routed from foreclose property historical performance database (FIG. 3) then generating with code generator an investment grade for the mortgage of current on the market active mortgage performance database; assigning a speculative tranche for a tranche pooled with mortgage down payment % active mortgage less than calculated 1 standard deviation of historical foreclosed properties % sales prices fall short of original asset prices is a speculative tranche by utilizing self-referential software module programmed with logical function (if) % of mortgage down payment divided with division function by collateral value is less than 1 standard deviation of % of asset sales prices fall short of original collateral value routed from foreclose property historical performance database (FIG. 3) then generating with code generator a speculative code for the mortgage; sorting with software sorting function the uniformly formatted current on the market active mortgage performance database (FIG. 5) per updated tranche code from above steps; therefore, pooling individual mortgages into specific order as structural tranches of MBS (mortgage backed securities). Assigning tranches code per calculated statistical standard deviation of % of asset sales prices fall short of original collateral value are neither limited to above tranches and could be pooled between 0.01 and 4 standard deviation of asset sales prices fall short of original collateral value nor excluding naming tranches besides risk free tranche, investment grade tranche, or speculative tranche.

Utilizing the system to integrating database and calculating the statistical standard deviation of % of asset sales prices fall short of original collateral value, wherein the system comprises at least one transaction processing computer, recordable data storage equipped with hardware memory media for 30 years' assets data, and processor equipped with the calculation functions software including addition, subtraction, division, multiplication, statistical standard deviation, table, subtotal, internal rate of return, regression, database, table linking, table lookup and logical functions IF to pull only data with downside pricing variances; however, calculation functions neither excluding other hardware, software functions or in-house programming to achieve the same result which is pooling MBS tranches per statistical standard deviation of % of asset downside pricing variances nor excluding the integration of other factors with this pooling method which is based on calculated statistical standard deviation of % of final asset sales prices fall short of original collateral assets.

### OPERATION

All tables designed are filterable per any fields in the heading; therefore, the downside risk of FIG. 3 could be populated per year, region, and any other preferred fields per institutions' special needs. For example, if the 113% weighted average cover rate of Collateral to Loan ratio of FIG. 5 represents unfiltered overall portfolio cover rate then buying tranche AA with higher price and lower return might be unnecessary since the overall cover rate is already above 12%. These tables are not to cover all fields which could be added per institutions' special needs. The main idea is enabling investors to view risk under the vast pool of MBS with readily available and verifiable data.

### ADVANTAGES

Currently MBS are stripped or pooled in tranche per prepayment risk. Advantages of pooling assets per principal at risk will broader range of investors with perseverance of capital as main concern. Verifiable database available to investors decompose the risk and increase the transparency for the products. These data available to investors are objective and verifiable; therefore, will enhance confident and liquidity for the secondary MBS market.

### CONCLUSION

The more secure tranches with default remote risk of non-agency MBS will deem to have the strongest liquidity. The speculated tranche will then provide higher rate of return to compensate the risk for more sophisticated investors.

Pooling of tranche is not limited to categories provided and could be more granular or more general per specific needs. The exact composition of pool may vary depending on the goals of the vehicle. Pooling of tranche could be also enhanced with other critical data per type of assets (rent rate for commercial property, etc.). Other risk statistic factors could also be integrated in the system.

The main idea here is to pool tranches per actual historical statistic data with perseverance of principal as main concern. Database provided are not to cover all fields which could be added per institutions' special needs.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A computer implemented method for structuring mortgage-backed security into tranches per statistical standard deviation of downside pricing variance of collateral, the method comprising:
a) retrieving, by a computing system, foreclose-property historical performance database configured to compute and store several bound of standard deviation of percentage of final market sale price fall short of original collateral value of a plurality of foreclose property for a predetermined period as tranches structure guiding rules to tranche asset backed security;
b) retrieving, by a computing system, current on the market active mortgage database to integrate databases with self-referral software to link down payment % of active mortgages with tranches structure guiding rules of foreclose property historical performance database from step (a) above;
c) processing, by the computing system, the current on the market active mortgage database with software sorting function to change order of individual mortgages per updated tranche field code into pool of tranches as structural mortgage backed securities in dollar amount tranches wherein percentage of active mortgage down payment is within structure guiding rules bounded by standard deviation of downside pricing variances of original collateral as market tradable products backed with historical databases and standard deviation calculations of assets downside pricing variances.

2. The method of claim 1, wherein retrieving current on the market active mortgage performance database to integrate databases further comprising:
a) configuring current on the market active mortgage performance database, by the computing system equipped with software table linking lookup function linking statistically calculated 3, 2 and 1 standard deviation of percentage of asset final sales prices fall short of original collateral assets prices from a foreclose property historical performance database as structure tranches guiding rules;
b) updating tranche field of current on the market active mortgage database with structure tranches guiding rules by the computing system configured with self-referential software module equipped with code generator, to generate tranche code by integrating active market mortgage's down payment percentage with a software database table function look up to link statistical calculated 3, 2, and 1 standard deviation of percentage of asset sales prices fall short of original collateral value from foreclose property historical performance database with programmed logical function if down payment percentage is within the bound of said structure guiding rules.

3. The method of claim 2, wherein updating the tranche field with structure change guiding rules further comprises the steps:
a) assigning a risk free tranche for a tranche pooled with mortgage down payment percentage of current on the market active mortgage performance database equals or more than calculated 3 standard deviation of foreclosed properties historical % of sales prices fall short of original asset prices to protect against 99.97% or more of downside asset pricing variances is a risk free tranche by utilizing self-referential software module programmed with logical function (if) % of mortgage down payment divided with division function by collateral value greater or equal than embedded 3 standard deviation of % of asset sales prices fall short of original collateral value routed from foreclose property historical performance database then generating a risk free code with code generator for the mortgage;
b) assigning an investment grade tranche for a tranche pooled with mortgage down payment % of active mortgages between bound of calculated 1 & 2 standard deviation of historical foreclosed properties % of sales prices fall short of original asset prices to protect against 68% of downside asset pricing variance is an investment grade tranche by utilizing self-referential software module programmed with logical function (if) % of mortgage down payment divided with division function by collateral value is greater or equal 1 standard deviation but less or equal 2 standard deviation of % of asset sales prices fall short of original collateral value routed from foreclose property historical performance database then generating with code generator an investment grade for the mortgage;
c) assigning a speculative tranche for a tranche pooled with % of mortgage down payment of active mortgage less than calculated 1 standard deviation of historical foreclosed properties % sales prices fall short of original asset prices is a speculative tranche by utilizing self-referential software module programmed with logical function (if) % of mortgage down payment divided with division function by collateral value is less than 1 standard deviation of % of asset sales prices fall short of original collateral value routed from foreclose property historical performance database, then generating with code generator a speculative code for the mortgage;
d) sorting with software sorting function the uniformly formatted current on the market active mortgage database per updated tranche code from previous steps; therefore, pooling individual mortgages into specific order as structural tranches;
e) assigning tranches code per calculated statistical standard deviation of % of asset sales prices fall short of original collateral value are neither limited to above tranches and could be pooled between 0.01 and 4 standard deviation of % of asset sales prices fall short of original collateral value nor excluding naming tranches besides risk free tranche, investment grade tranche, or speculative tranches;
f) pooling tranches neither excluding the integration of other factors with this pooling method which is based on calculated statistical standard deviation of % of final asset sales prices fall short of original collateral assets nor excluding other hardware, software functions or in-house programming to achieve the same result which is structuring mortgage backed security tranche per downside pricing variances of market sales fall short of original collateral.

4. The method of claim 1, wherein retrieving foreclose property historical performance database configured to compute and store standard deviation further comprise following steps:
a) utilizing software module programmed with logical function if sales price is greater or equal than collateral value of foreclose property historical performance database then converting with equal function the downside risk field to zero since pricing variance of negative loss is the only concern; otherwise, subtracting sales price with software subtraction function by collateral value over collateral value with software division function as the % of downside pricing variance;
b) determining the standard deviation of % of asset sales prices fall short of original collateral value by utilizing software module equipped with database table function configured to weighted average subtotal standard deviation and calculating the weighted average subtotal of % of downside risk field deriving from step (a) based on foreclose property historical performance data;
c) calculating and storing with a recordable storage medium equipped with hardware memory for 30 years or more of asset data to compute statistical 3, 2, and 1 standard deviation of % of asset sales prices fall short of original collateral value by multiplying 3, 2, and 1 to the weighted average variances subtotal derived from step (b) above by utilizing software module configured with multiply function, wherein software calculation functions neither excluding other software functions or in-house programming to achieve the same result which is pooling MBS tranches per statistical standard deviation of % of asset sales prices fall short of original collateral value, nor excluding other type of hardware to achieve the same result which is pooling mortgage backed security tranches per statistical standard deviation of downside collateral pricing variances.
d) utilizing the computing system to calculate the statistical standard deviation of % of asset sales prices fall short of original collateral value, wherein the computing system comprises at least one transaction processing system, recordable data storage server equipped with hardware memory media for 30 years' or more of assets data, and processor equipped with the calculation functions software including addition, subtraction, division, multiplication, statistical standard deviation, table, subtotal, internal rate of return, regression, database, table linking, table lookup and logical functions IF to pull only data with downside pricing variances.
